(19) United States
(12) Patent Application Publication
(10) Pub. No.: US 2026/0212159 A1
(43) Pub. Date: Jul. 23, 2026

(54) COMPUTING SYSTEMS AND METHODS FOR EVENT PREDICTION USING A MACHINE LEARNING MODEL

(71) Applicant: The Toronto-Dominion Bank, Toronto (CA)

(72) Inventors: Brendan Leigh Ross, Toronto (CA); Jesse Cole Cresswell, Toronto (CA); Maksims Volkovs, Toronto (CA)

(21) Appl. No.: 19/035,290

(22) Filed: Jan. 23, 2025

(51) Int. Cl. G06N 3/0455; G06Q 40/02

(52) U.S. Cl. CPC G06N 3/0455; G06Q 40/02

(57) ABSTRACT

Methods and systems for performing event prediction using a machine learning model. The methods include training, using a diffusion model and a plurality of synthetic tabular datasets representing a prior, a machine learning model to generate a tabular dataset that has a distribution that is consistent with the prior; conditioning the trained machine learning model to: receive (i) an input tabular dataset comprising one or more datapoints, each datapoint comprising one or more elements, and (ii) information identifying one or more elements of the input tabular dataset that are to be predicted, and predict the identified one or more elements of the input tabular dataset based on the other elements of the input tabular dataset; and using the conditioned trained machine learning model to perform event prediction.

### TECHNICAL FIELD

The disclosed example embodiments relate to computer-implemented methods and systems for event prediction using a machine learning model and more specifically, predicting the likelihood of an event occurring using a variant of a prior-data fitted network.

### BACKGROUND

Machine learning models can be used to predict the likelihood of an event occurring by training machine learning models to identify patterns that indicate the likelihood of the event. Such models can be used for event prediction in a variety of industries including, but not limited to, healthcare, education, manufacturing, energy and utilities, technology and cybersecurity, real estate and construction, transportation and logistics, education, and hospitality and travel.

Traditionally machine learning models are trained to perform a specific task. Specifically, traditionally machine learning models are trained on a specific labelled dataset to learn and replicate the relationship between the input(s) and the output(s) in the labelled dataset. For example, as shown in FIG. 1, a machine learning model may be trained to predict an output y based on an input x from a training dataset comprising (x, y) pairs. At inference time the trained model receives a new x and generates a prediction for y.

However, when a model is trained on a specific dataset, it is difficult to use that model for a different dataset. In other words, a model trained to make a prediction based on one dataset may be suboptimal at making a prediction based on another dataset. For example, a machine learning model trained to predict the likelihood of a flight being delayed in response to a set of features related to a flight based on a training dataset comprising (set of features related to a flight, whether the flight was delayed) pairs may be suboptimal at predicting the likelihood of an individual defaulting on a credit card in response to a set of features related to the individual and their credit card in accordance with a dataset that comprises (set of features related to an individual and their credit card, whether the individual defaulted on the credit card) pairs. To obtain a prediction based on the other dataset (e.g., the dataset that comprises (set of features related to the individual and their credit card, whether the individual defaulted on the credit card) pairs, it may be necessary to train another model on the other dataset.

Generating and maintaining a separate model for each event for which predictions may be desired is both labour and time intensive and requires significant computing resources to store each model.

### SUMMARY

The following summary is intended to introduce the reader to various aspects of the detailed description, but not to define or delimit any invention.

A first aspect provides a system for performing event prediction, the system comprising: a memory, a communication interface, and at least one processor operatively coupled to the memory and the communication interface; the at least one processor configured to: train, using a diffusion model and a plurality of synthetic tabular datasets representing a prior, a machine learning model to generate a tabular dataset that has a distribution that is consistent with the prior; condition the trained machine learning model to: receive (i) an input tabular dataset comprising one or more datapoints, each datapoint comprising one or more elements, and (ii) information identifying one or more elements of the input tabular dataset that are to be predicted, and predict the identified one or more elements of the input tabular dataset based on the other elements of the input tabular dataset; and use the conditioned trained machine learning model to perform event prediction.

The at least one processor may be configured to use the conditioned trained machine learning model to perform event prediction by providing the conditioned trained machine learning model with (i) an event input tabular dataset comprising a plurality of datapoints and (ii) event information identifying one or more elements of the event input tabular dataset to be predicted, and the plurality of datapoints may comprise one or more training datapoints and an input datapoint, and the event information may identify an element of the input datapoint to be predicted.

Each training datapoint may comprise a set of elements that represent a set of features of a record and an element that represents an occurrence of the event for the record, and the input datapoint may comprise a set of elements that represent the set of features for a new record.

The input datapoint may comprises an element that represents an occurrence of the event for the new record and the element that represents the occurrence of the event for the new record may not comprise valid data; and the event information may identify the element of the input datapoint that represents the occurrence of the event for the new record as an element to be predicted such that the conditioned trained machine learning model predicts the occurrence of the event for the new record.

The event information may comprise a mask.

The machine learning model may comprise a transformer architecture.

The machine learning model may be configured to tokenize each element of the event input tabular dataset.

Using the conditioned trained machine learning model to perform event prediction may comprise using the conditioned trained machine learning model to predict a likelihood of an entity requesting a financial product within a predetermined period of time.

The financial product may be a credit card, unsecured line of credit, unsecured loan, real estate secured lending, investing account, checking account, personal investment, savings account, term life policy, overdraft protection, trade account, travel medical insurance, or balance protection insurance.

Using the conditioned trained machine learning model to perform event prediction may comprise using the conditioned trained machine learning model to predict fraudulent activity related to a financial product.

Predicting the fraudulent activity related to the financial product may comprises predicting an account take over risk, predicting mule account risk, predicting money laundering account risk, predicting application fraud, or predicting breach of an account.

Using the conditioned trained machine learning model to perform event prediction may comprise using the conditioned trained machine learning model to predict delinquency related to a financial product.

The financial product may comprise a credit card, an unsecured line of credit, an unsecured loan, or a real estate secured lending.

The at least one processor may be further configured to generate one or more synthetic tabular datasets of the plurality of synthetic tabular datasets by sampling a Bayesian neural network.

The at least one processor may be further configured to generate one or more synthetic tabular datasets of the plurality of synthetic tabular datasets by sampling a structural causal model.

The at least one processor may be configured to train the machine learning model using the diffusion model and the plurality of synthetic tabular datasets by diffusing each of the plurality of synthetic tabular datasets in accordance with a diffusion process to generate a plurality of diffused datasets and adjusting parameters of the machine learning model so that the machine learning model reverses the diffusion process on the plurality of diffused datasets.

Adjusting the parameters of the machine learning model so that the machine learning model reverses the diffusion process may comprise adjusting the parameters of the machine learning model so that the machine learning model generates, in response to receiving a diffused dataset, the corresponding synthetic tabular dataset.

A second aspect provides a method for performing event prediction, the method executed in a computing environment comprising at least one processor, a communication interface, and memory, and the method comprising: training, using a diffusion model and a plurality of synthetic tabular datasets representing a prior, a machine learning model to generate a tabular dataset that has a distribution that is consistent with the prior; conditioning the trained machine learning model to: receive (i) an input tabular dataset comprising one or more datapoints, each datapoint comprising one or more elements, and (ii) information identifying one or more elements of the input tabular dataset that are to be predicted, and predict the identified one or more elements of the input tabular dataset based on the other elements of the input tabular dataset; and using the conditioned trained machine learning model to perform event prediction.

Using the conditioned trained machine learning model to perform event prediction may comprise providing the conditioned trained machine learning model with an event input tabular dataset comprising a plurality of datapoints and event information identifying one or more elements of the event input tabular dataset to be predicted, wherein the plurality of datapoints comprise one or more training datapoints and an input datapoint, and the event information identifies an element of the input datapoint to be predicted.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic diagram illustrating inputs and outputs of a traditional trained machine learning model;

FIG. 2 is a schematic diagram illustrating inputs and outputs of a prior-data fitted network (PFN);

FIG. 3 is a schematic diagram illustrating inputs and outputs of a diffusion PFN;

FIG. 4 is a block diagram of an example system for generating a conditioned diffusion PFN and using the conditioned diffusion PFN to perform event prediction;

FIG. 5 is a block diagram of an example implementation of the cloud-based computing cluster of FIG. 4 configured to generate a conditioned diffusion PFN and use the conditioned diffusion PFN to perform event prediction;

FIG. 6A is a schematic diagram of an example Bayesian neural network (BNN);

FIG. 6B is a schematic diagram of an example Structural Causal Model (SCM);

FIG. 6C is a schematic diagram of example SCMs sampled from a prior;

FIG. 7A is a schematic diagram illustrating a first example of using a conditioned diffusion PFN to generate tabular data;

FIG. 7B is a schematic diagram illustrating a second example of using a conditioned diffusion PFN to generate tabular data;

FIG. 8 is a block diagram of an example computer; and

FIG. 9 is a flow diagram of an example method for event prediction using a machine learning model.

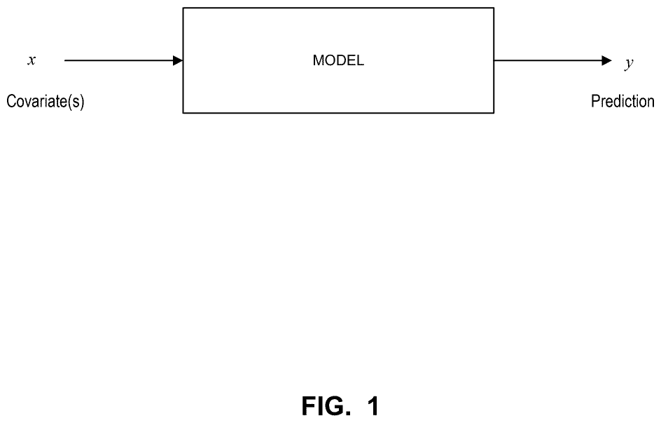

### DETAILED DESCRIPTION

Described herein are methods and systems for performing event prediction using a variant of a prior-data fitted network (PFN) trained to process tabular data. As described below, once trained, the described PFN variant can be used to predict a variety of different events, without retraining the model.

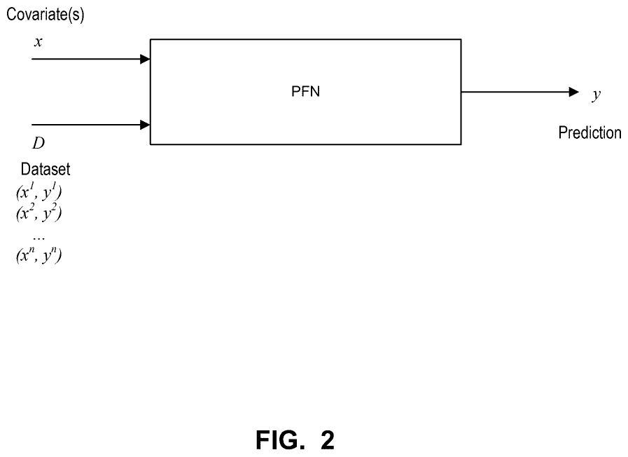

Mueller et al. in “Transformers Can Do Bayesian Inference”, International Conference of Learning Representations, 2021, introduce the concept of a PFN which is a large machine learning model, such as a Transformer encoder, which is trained offline once, to approximate Bayesian inference on synthetic datasets from a prior. Specifically, as shown in FIG. 2, a PFN is designed to receive an input x, and a test or reference dataset, D, comprising an arbitrary number n of datapoints

$${d}^{( i )} = ( {x}^{( i )} , {y}^{( i )} ) = ( {d}_{1}^{( i )} , … , {d}_{k}^{( i )} ) where {d}_{k}^{( i )} = y$$

and y⁽ⁱ⁾ is the output for x⁽ⁱ⁾

$$( i . e . , D = \{ {d}^{( 1 )} , … , {d}^{( n )} \} = {\{ ( {x}^{( i )} , {y}^{( i )} ) \}}_{i = 1}^{n} ) ;$$

and predict an output y based on x and D. More specifically the PFN is configured to generate the posterior predictive distribution (PPD) p(y|x,D)—i.e., the distribution over possible values of y for the input x—in a single forward pass.

A PFN is pre-trained on a plurality of distinct test datasets which are synthetically generated from a prior. This pre-training may be referred to as the prior fitting stage or phase, or the offline phase. Specifically, a plurality of synthetic datasets are generated by sampling a prior. In particular, each synthetic dataset comprise a plurality of samples/datapoints d⁽ⁱ⁾=(x⁽ⁱ⁾,y⁽ⁱ⁾). For each of the plurality of synthetic datasets a test dataset D is generated which comprises a subset of the samples d⁽ⁱ⁾=(x⁽ⁱ⁾, y⁽ⁱ⁾) in the synthetic dataset. The number of samples that form a test dataset are randomly selected from the synthetic dataset. The synthetic datasets and test datasets have an arbitrary size such that different synthetic datasets and different test datasets may have a different number of samples. The samples from a synthetic dataset which do not form part of the corresponding test dataset are referred to as the holdouts. The PFN is trained to predict or generate the holdouts for each synthetic dataset from the corresponding test dataset.

For example, if a synthetic dataset comprises samples/datapoints d(1)=(x⁽¹⁾, y⁽¹⁾), d⁽²⁾=(x⁽²⁾), y⁽²⁾), d⁽³⁾=(x⁽³⁾), y⁽³⁾), d⁽⁴⁾ (x⁽⁴⁾), y⁽⁴⁾) and d⁽⁵⁾=(x⁽⁵⁾, y⁽⁵⁾), and the test dataset D comprises only samples/datapoints d⁽¹⁾=(x⁽¹⁾, y⁽¹⁾), d⁽²⁾=(x⁽²⁾), y⁽²⁾), and d⁽⁵⁾=(x⁽⁵⁾), y⁽⁵⁾), then the PFN is trained to (i) predict y⁽³⁾ from x⁽³⁾ and D; and (ii) predict y⁽⁴⁾ from x⁽⁴⁾ and D. Specifically, Muller et al. propose updating the parameters of the machine learning model via gradient descent to minimizing the log-likelihood.

The PFN learns properties to generalize over the plurality of synthetic datasets. In this manner the PFN is trained to learn the posterior predictive distribution (PPD) p(y|x,D). In some cases, there may be millions of synthetic datasets.

Mueller et al. indicate that many neural architectures can be used as the machine learning model. However, they explored architectures based on the Transformer encoder and a novel regression head for regression problems. Specifically, Mueller et al. describe an architecture based on a Transformer encoder without positional encodings, which makes it invariant to permutations in the dataset. The Transformer encodes each datapoint (e.g., each feature vector (x) and label (y) combination) as a token, allowing token representations to attend to each other. For example, training samples/datapoints d⁽¹⁾=(x⁽¹⁾, y⁽¹⁾), d⁽²⁾=(x⁽²⁾, y⁽²⁾), d⁽³⁾=(x⁽³⁾, y⁽³⁾), are transformed to 3 tokens, which attend to each other and test samples x⁽⁴⁾, and x⁽⁵⁾ attend only to the training samples.

Once the PFN has been pre-trained, the PFN can receive a new test or reference dataset D and an input or query x and predict y (i.e., generate p(y|x,D)). This may be referred to as the prediction or online stage or phase. The test or reference dataset can change from one inference to another such that the PFN performs in-context learning. Thus, the weights of a pre-trained PFN do not need to be updated to be able to generate a prediction for a new dataset. In contrast, the PFN has this knowledge built in.

Mueller et al. demonstrated that PFNs can be used to perform tabular classification problems. However, their work was limited to 30 training samples, balanced binary classification and 60 features.

Hollman et al. in “TabPFN: A Transformer That Solves Tabular Classification Problems In a Second”, The Eleventh International Conference on Learning Representations, 2022, built on the PFN concept to develop TabPFN, a trained Transformer that can do supervised classification for small tabular datasets. Specifically, Hollman et al. designed a prior based on Bayesian Neural Networks and Structural Causal Models (SCMs) to model complex feature dependencies and potential causal mechanisms underlying tabular data and trained a PFN on samples from the prior. In particular, the prior has a large space of structural causal model with preference for simple structure. After training, the trained TabPFN model accepts training samples (xₜᵣₐᵢₙ, yₜᵣₐᵢₙ) and test features xₜₑₛₜ, and yields predictions yₜₑₛₜ for the entire test set in a single forward pass.

By extending the prior (vs PFN), TabPFN can handle imbalanced classes and multi-classification problems. Furthermore, while PFNs use an encoder layer that accepts fixed dimensional inputs, Tab PFN accepts datasets with different numbers of dimensions. Hollman et al. proposed a 12 layer Transformer, embeddings size 512, hidden size 1024 in feed forward layers and 4-head attention.

It has been shown that a TabPFN can generalize to virtually any tabular dataset (a dataset comprising columns and rows) through in context learning.

Since PFNs and TabPFNs are configured to predict the label(s) y, PFNs and TabPFNs are suitable for classification and regression problems. Specifically, classification and regression are both supervised machine learning techniques that use labeled data (e.g. (x⁽ⁱ⁾, y⁽ⁱ⁾) pairs) to find patterns and predict outcomes. They differ in the type of output. Specifically, classification predicts categorical output, such as a label or class from a predefined list. In contrast, regression predicts continuous numerical output, such as a real-valued number that can vary within a range. However, it would be desirable to have a foundation model that can perform generative tasks (e.g., generate data) on/for tabular data.

Ma et al. in “TabPFGen=Tabular Data Generation with TabPFN”, NeurIPS 2023 Second Table Representation Workshop, 2023, devised a technique to turn TabPFN into an energy-based generative model, which is referred to as TabPFGen. TabPFGen leverages the strong in-context performance of TabPFN to devise a class-conditional generative model. In particular, TabPFGen generates p(x|y) using TabPFN. Specifically, given a trained TabPFN model ƒ, TabPFGen obtains ƒ(x_{synth}) using (xₜᵣₐᵢₙ, yₜᵣₐᵢₙ) as training data. Then the class conditioned energy E(x|y):=−ƒ(x)[y] is computed using E(x_{synth}|y_{synth}):=−ƒ(x_{synth})[y_{synth}]. The stochastic gradient Langevin dynamics (SGLD) method is then used to sample from this energy-based model to generate a batch of x_{synth}. TabPFN harnesses a pre-trained TabPFN to generate an energy based model for tabular data generation without additional training.

Accordingly, TabPFN provides a way to sample from the in context-distribution p(d|D). In other words, it gives the distribution of a datapoint given a training dataset. However, it would be more beneficial to be able to generate the whole unconditional distribution p(D). Specifically, once a generative model has learned the full unconditional distribution p(D), then in principle the generative model can then generate from any conditional

$$p ( ( {d}_{{j}_{1}}^{( {i}_{1} )} , … , {d}_{{j}_{l}}^{( {i}_{l} )} ) \vert {D}_{test} ∖ ( {d}_{{j}_{1}}^{( {i}_{1} )} , … , {d}_{{j}_{l}}^{( {i}_{l} )} ) )$$

—i.e., it can then impute any missing entries in a dataset given the rest of a dataset. Thus, any combination of individual entries or elements

$${d}_{j}^{( i )}$$

of a dataset can be imputed.

While it is possible to argue that in principle learning p(d|D) is sufficient for imputing individual entries or elements

$${d}_{j}^{( i )}$$

of a datapoint, learning p(D) allows the model to generate entries that are correlated across datapoints. Imputations that are correlated across datapoint are highly desirable since it is desirable for imputations to be consistent across datapoints. Furthermore, learning p(D) is conceptually simpler and easier to implement in terms of time and computing resources that learning p(d|D).

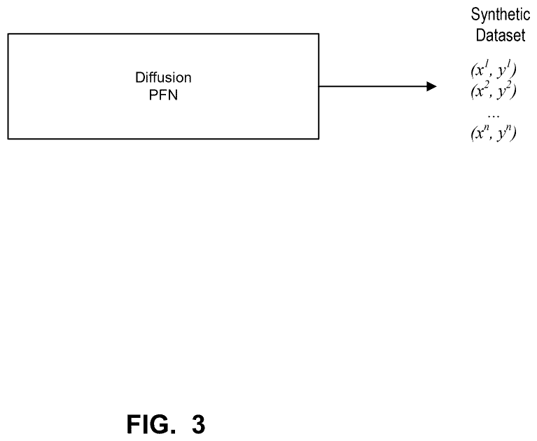

Accordingly described herein are methods and systems for performing event prediction using a machine learning model by generating a generative foundation model for tabular data and using that generative foundation model to predict the event. Specifically, in the examples described herein first, a variant of a PFN, which is referred to herein as a diffusion PFN, is generated by training, using a diffusion model and a plurality of different synthetic datasets from a prior, a large machine learning model (e.g., a transformer model) to generate an entire synthetic dataset which has a distribution that is consistent with the prior. The plurality of synthetic datasets may be generated, for example, in a similar manner to how the synthetic datasets are generated for a PFN or TabPFN (e.g., by randomly sampling a prior). Accordingly, where PFNs and TabPFNs generate p(y|x,D), a diffusion PFN generates p(D) directly. Thus, as shown in FIG. 3, a diffusion PFN can generate an entire synthetic dataset (e.g., a set of datapoints (x,y)) from scratch. A diffusion PFN is therefore a generative foundation model.

Once the machine learning model (i.e., diffusion PFN) has been trained to generate an entire synthetic dataset, the trained machine learning model is conditioned to perform imputation (i.e., estimating or inferring missing values in a dataset using algorithms and other datapoints). A conditioned generative model takes additional inputs as conditions to control the generation process. In some cases, the trained machine learning model may be conditioned to impute any missing entries in an input dataset given the rest of a dataset—i.e., the trained machine learning model can be conditioned to generate

$$p ( ( {d}_{{j}_{1}}^{( {i}_{1} )} , … , {d}_{{j}_{l}}^{( {i}_{l} )} ) \vert {D}_{test} ∖ ( {d}_{{j}_{1}}^{( {i}_{1} )} , … , {d}_{{j}_{l}}^{( {i}_{l} )} ) ) .$$

As described in more detail below, this may be implemented, for example, by conditioning the trained machine learning model down to receive (i) an input dataset and (ii) information (e.g., a mask) indicating which datapoints or elements of the input dataset are to be predicted or generated; and generate the identified elements of the input dataset based on the other elements of the input dataset.

Once the trained machine learning model has been conditioned to impute any missing entries in a dataset given the rest of the dataset, the conditioned and trained machine learning model (which may be referred to herein as the conditioned diffusion PFN) can be used to perform event prediction. Specifically, the conditioned diffusion PFN can be used to predict the likelihood of the event based on features related to the event by providing the conditioned diffusion PFN with an input tabular dataset that comprises a plurality of datapoints, wherein each datapoint comprises a plurality of elements. The plurality of datapoints comprise one or more test or training datapoints and an input datapoint. Each training datapoint comprises a set of elements that represent a set of features related to an example (e.g., historical) record and an element indicating whether the event occurred for that record. The input datapoint (which may, in some cases, be the last datapoint in the input tabular dataset) comprises a set of elements that represent the set of features for a new record but does not comprise a valid element that represents whether the event occurred. The conditioned diffusion PFN is then instructed (e.g., via a mask) to generate or predict the missing element of the input tabular dataset—i.e., the element representing the event occurrence for the new record—based on the other elements of the input dataset. In other words, the conditioned diffusion PFN generates a prediction of whether the event occurred based on the set of features for the new record and the training datapoints.

For example, if the objective is to predict whether an individual will default on a credit card (e.g. whether the individual will miss multiple required payments over a period of time such that the credit card issuer writes the debt off as a loss) then an input tabular dataset with n datapoints may be provided to the conditioned diffusion PFN wherein: each of datapoints 1 to n−1 are training datapoints that comprise (i) elements that represent a set of features related to an example individual that are relevant to credit card default such as, but not limited to, age, credit score, salary etc., (ii) and an element that represents whether the individual defaulted on the credit card; and datapoint n is the input datapoint that comprises elements that represent to the set of features for a new individual who has applied for a credit card. The input data point (i.e., datapoint n) does not comprise a valid element that represents whether the individual defaulted on their credit card. The conditioned diffusion PFN is then instructed (e.g., via a mask) to predict the missing element based on the other elements of the input tabular dataset. In other words, the mask instructs the conditioned diffusion PFN to predict whether the individual will default on the credit card based on the set of features for the individual and the training datapoints.

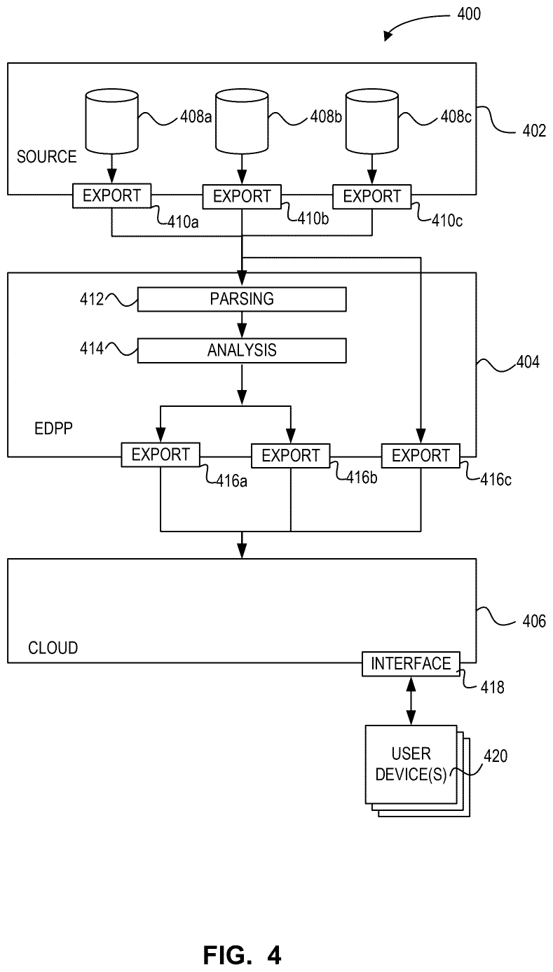

Reference is now made to FIG. 4, which illustrates a block diagram of an example computing system 400 for performing event prediction using a machine learning model. Computing system 400 comprises a source database system 402, an enterprise data provisioning platform (EDPP) 404 operatively coupled to the source database system 402, and a cloud-based computing cluster 406 that is operatively coupled to the EDPP 404.

Source database system 402 has one or more databases, of which three are shown for illustrative purposes: database 408a, database 408b and database 408c. One or more of the databases of the source database system 402 may contain confidential information that is subject to restrictions on export. One or more export modules 410a, 410b, 410c may periodically (e.g., daily, weekly, monthly, etc.) export data from the databases 408a, 408b, 408c to the EDPP 404. In some instances, the data is exported on an ad hoc basis.

EDPP 404 receives source data exported by the export modules 410a, 410b, 410c of source database system 402, processes it and exports the processed data to an application database within the cloud-based computing cluster 406. For example, a parsing module 412 of EDPP 404 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 414 or an export module 416a, 416b, 416c. In particular, parsed data can then be processed and transmitted to the cloud-based computing cluster 406 by a reporting and analysis module 414. Alternatively, one or more export modules 416a, 416b, 416c can export the parsed data to the cloud-based computing cluster 406.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 404 may “de-risk” data tables that contain confidential data prior to transmission to cloud-based computing cluster 406. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 406 is configured to generate a diffusion PFN, condition the generated diffusion PFN to generate a conditioned diffusion PFN, and use the conditioned diffusion PFN and data received from the EDPP 404 to perform event prediction. The cloud-based computing cluster 406 includes an interface 418, which facilitates data communication with one or more user devices 420.

In some environments, the EDPP may be omitted. In such cases the cloud-based computing cluster 406 may receive the data, for use with the conditioned diffusion PFN, directly from the source database system 402.

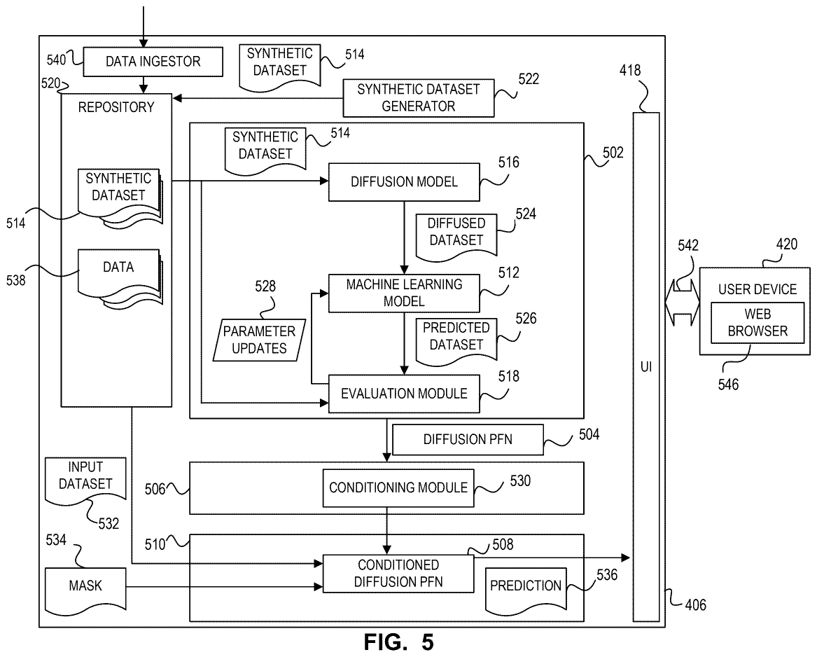

Reference is now made to FIG. 5, which illustrates an example implementation of the cloud-based computing cluster 406 of FIG. 4. As described above, the cloud-based computing cluster 406 is configured to perform event prediction using a machine learning model by generating a generative foundation model for tabular data and using that generative foundation model to perform the event prediction. In the example shown in FIG. 5 the cloud-based computing cluster 406 comprises a first system 502 which is configured to generate a generative foundation model, which is referred to herein as a diffusion PFN 504, which can generate a tabular dataset; a second system 506 which is configured to modify the diffusion PFN 504 to generate a conditioned diffusion PFN 508 which can perform imputation on an input tabular dataset; and a third system 510 which is configured to use the conditioned diffusion PFN 508 to perform event prediction.

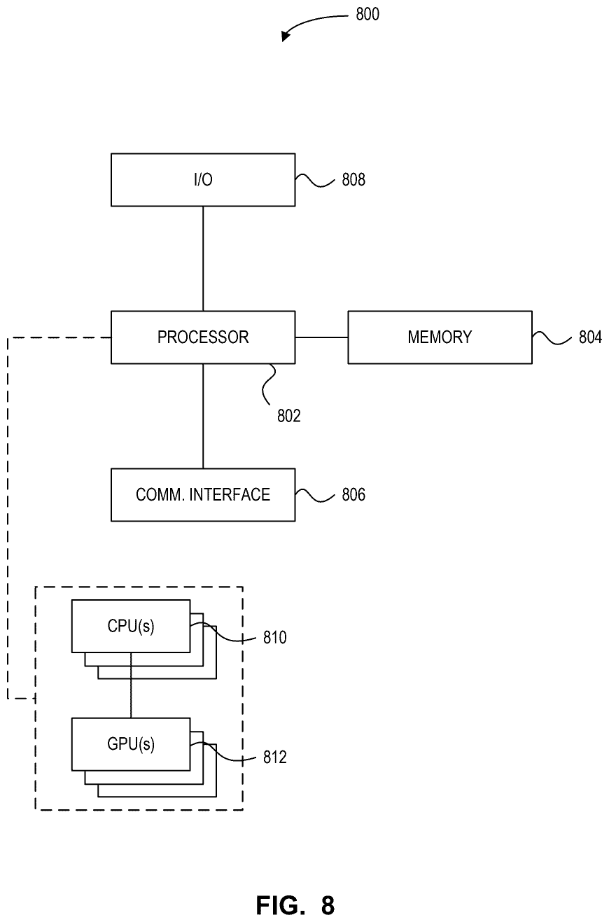

In some cases, one or more components of the cloud-based computing cluster 406 may be implemented by one or more computers within the cloud-based computing cluster, such as, but not limited to, computer 800 described below with respect to FIG. 8. In some cases, one or more components of the cloud-based computing cluster 406 may be implemented as virtual machines within the cloud-based computing cluster 406.

The first system 502 is configured to generate the diffusion PFN 504 by training a machine learning model 512 to generate a plurality of synthetic tabular datasets 514 (i.e., to generate p(D)) using a diffusion model (e.g., using diffusion modelling). In the example shown in FIG. 5, the first system 502 comprises the machine learning model 512, a diffusion model 516 and an evaluation module 518.

The plurality of synthetic tabular datasets 514 are synthetic datasets D generated by sampling a prior. Each synthetic dataset, D, comprises an arbitrary number n of datapoints

$${d}^{( i )} = ( {x}^{( i )} , {y}^{( i )} ) = ( {d}_{1}^{( i )} , … , {d}_{k}^{( i )} ) where {d}_{k}^{( i )} = y$$

and y⁽ⁱ⁾ is the output for x⁽ⁱ⁾

$$( i . e . , D = \{ {d}^{( 1 )} , … , {d}^{( n )} \} = {\{ ( {x}^{( i )} , {y}^{( i )} ) \}}_{i = 1}^{n} ) . Each {d}_{j}^{( i )}$$

of a datapoint is referred to as an entry or an element of the datapoint. An entry that forms part of x⁽ⁱ⁾ is referred to as feature, and an entry that forms part of y⁽ⁱ⁾ is referred to as a target or a label. n and k can vary between datasets such that the number of datapoints per dataset and the number of entries per datapoint may vary between datasets.

In some cases, the plurality of synthetic tabular datasets 514 are generated from a prior that represents tabular datasets in the real world. In some cases, the prior is based on Structural Causal Models (SCMs) and/or Bayesian Neural Networks to model complex feature dependencies and potential causal mechanisms underlying tabular data as described by Hollman et al.

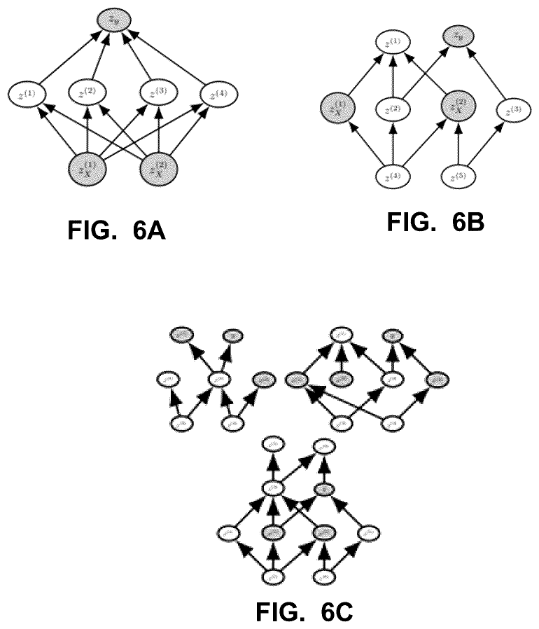

Specifically, since tabular data often exhibits causal relationships between columns, in some cases, the prior for the diffusion PFN may be based on SCMs that model causal relationships. An SCM is a collection Z:=({z₁, . . . , zₖ}) of structural assignments (called mechanisms): zᵢ=ƒᵢ(z_{PA}_{_{G(i)}}, ∈ᵢ), where PA_{G(i)} is the set of parents of the node i (its direct causes) in an underlying DAG G (the causal graph), ƒᵢ is a (potentially nonlinear) deterministic function and ∈ᵢ is a noise variable. Causal relationships in G are represented by directed edges pointing from causes to effects and each mechanism zᵢ is assigned to a node in G. An example SCM is shown in FIG. 6B.

To create a prior based on SCMs a plurality of datasets may be generated wherein each dataset is based on one randomly-sampled SCM (including the DAG structure and deterministic functions ƒᵢ). Given an SCM, a set of nodes zₓ in the causal graph G are sampled (one for each feature) along with one node z_{y} from G. For each SCM and set of nodes (zₓ, z_{y}) a plurality (e.g., n) samples are generated by sampling all noise variables in the SCM n times. These are then propagated through the graph and the values for all the identified nodes (zₓ, z_{y}) are retrieved for all n samples. FIG. 6C shows example SCMs sampled from the prior.

In some cases, the prior may also, or alternatively, be based on Bayesian Neural Networks (BNNs). A BNN is a type of neural network that incorporates uncertainty into its predictions. Specifically, when a regular neural network makes a prediction, it gives a simple value based on the inputs. However, BNNs not only make a prediction but qualify the uncertainly. This is achieved by treating the weights of the BNN as distributions instead of fixed numbers. An example BNN is shown in FIG. 6A. In some cases, datasets for the prior may be generated by (1) sampling a BNN architecture; (2) sampling model weights for the selected architecture; (3) for each datapoint, an input is sampled for each feature; (4) for each datapoint, the selected features are fed through the BNN with sampled noise variables and the output y is used as the target for that set of features.

In some cases, the datasets may be sampled from either one or the other prior (SCN prior or BNN prior) with equal probability.

Where the SCN or the BNN returns a scalar label, in order to generate synthetic classification labels for imbalanced multi-class datasets the scalar labels may be transformed to discrete class labels. In some cases, this may be implemented by splitting the values of the scalar labels into intervals that map to class labels by: (1) sampling the number of classes N_{c}~p(N_{c}); (2) sampling N_{c}−1 class bounds Bi randomly from the set of continuous targets y; and (3) mapping each scalar label y to the index of the unique interval that contains it.

Generating synthetic datasets from a combination of SCMs and BNNs has proven a powerful inductive basis for applying large models, such as machine learning models with a transformer backbone, to small datasets.

In some cases, the synthetic tabular datasets 514 may be stored in a repository 520 of the cloud-based computing cluster 406. The repository 520 may be any mechanism or device, such as memory, that can store digital information. In some cases, the cloud-based computing cluster 406 may receive the plurality of synthetic tabular datasets 514 from, for example, the source database system 402 or the EDPP 404. However, in other cases, the cloud-based computing cluster 406 may comprise a synthetic dataset generator 522 which is configured to generate the plurality of synthetic tabular datasets 514 in accordance with any of the above methods.

The machine learning model 512 is a large and/or powerful machine learning model, such as, but not limited to, a deep learning model with a transformer architecture. In some cases, the machine learning model 512 is a deep learning model with a transformer architecture, however, instead of having one token per datapoint (i.e., per

$${d}^{( i )} = ( {x}^{( i )} , {y}^{( i )} ) = ( {d}_{1}^{( i )} , … , {d}_{y}^{( i )} ) )$$

like TabPFN, there is a token for each

$${d}_{j}^{( i )}$$

in a dataset—i.e., for each entry in the dataset. This allows any entry

$$( {d}_{j}^{( i )} )$$

in a dataset D to be imputed by its outputs. An example tokenizer which may be used to implement this is described in Zhang et al., “Mixed-Type Tabular Data Synthesis With Score-Based Diffusion in Latent Space”, arXiv preprint arXiv:2310.0956, 2023. Specifically, in the example tokenizer the dataset D is represented as a matrix

$${( {d}_{j}^{( i )} )}_{i , j}$$

and each column is converted into an n-dimensional vector. First one-hot encoding is used to process categorical features. Each datapoint is represented as a vector. Then, a linear transformation is applied for numerical columns which creates an embedding lookup table for columns, where each category is assigned a learnable n-dimensional vector. Now, each dataset is expressed as the stack of the embeddings of all columns. Having a token for each entry in a dataset, versus having a token for each datapoint, makes the context much larger.

Regarding positional encoding, where the dataset is represented by a matrix, the machine learning model 512 uses both column and row indices. However, it is desirable that the order of the columns and rows does not matter. Accordingly, in some cases, this may be addressed by using a random noise vector for each row zᵣ~N(0,I) and a random noise vector for each column z_{c}~N(0,I). In some cases, either or both of these random noise vectors may be added to the encoding of an entry in the dataset (e.g.,

$$( e . g . , {( {d}_{j}^{( i )} )}_{i , j} ) .$$

The diffusion model 516 and the evaluation module 518 are used to train the machine learning model 512 to generate entire datasets (i.e., p(D)) using diffusion modelling. Fundamentally, diffusion modelling works by corrupting training data, and then teaching a model to recover the original data by reversing this corruption process. Specifically, the model is trained to iteratively undo a forward corruption process q that corrupts clean data c and defines latent variables zₜ for t∈[0,1] that represent progressively noisy versions of c. After training, the trained machine learning model can be used to generate data that mimics the training data by simply passing random sampled noise to the trained model. Training a model using diffusion modelling has shown to be an effective method to train a model to generate continuous data but it also has been shown to handle the generation of discrete data.

The process of corrupting an input is called forward diffusion. In the example of FIG. 5, the forward diffusion is performed by the diffusion model 516. Specifically, the diffusion model 516 is configured to receive a synthetic tabular dataset 514 and corrupt the received synthetic tabular dataset to generate a corrupted or diffused dataset 524. The diffusion model 516 may gradually corrupt the received synthetic dataset over a series of steps. In some cases, the diffusion model 516 may be a patent variable model which maps to the latent space using a Markov chain. Specifically, this chain may gradually add Gaussian noise to the received synthetic dataset over a number of steps. In these cases, each step of the forward diffusion process may be defined by equation (1) where ε=N(0,I) and (αₜ)_{t∈[0,1]} is a noise schedule, monotonically decreasing in t. This has been shown to work well for continuous data.

$${z}_{t} = \sqrt{{α}_{t}} c + \sqrt{1 - {α}_{t}} ε \qquad ( 1 )$$

In other cases, the diffusion model 516 may implement masked or absorbing state diffusion. In masked diffusion or absorbing state diffusion, during the forward diffusion step the data is gradually transformed or “absorbed” into a specific state. This state could be a form of noise or even an absorbing state (a state that once reached, doesn't evolve further). This is done using a mask. Specifically, in each step a subset of the elements in the input are masked out. This gradually destroys the information in the input. If enough steps are performed you end up with a fully masked output. This has been shown to work well for discrete data. Any suitable masked or absorbing diffusion method may be used.

One example method of masked diffusion which may be implemented by the diffusion model 516 is described in Sahoo et al., “Simple and Effective Masked Diffusion Language Models”, arXiv e-prints, pages arXiv-2406, 2024. In this example, scalar discrete random variables with K categories are denoted as “one-hot” column vectors and

$$V ∈ \{ c ∈ {\{ 0 , 1 \}}^{K} : {\sum }_{i = 1}^{K} {c}_{i} = 1 \}$$

is defined as the set of all vectors. Cat(.;π) is defined at the categorical distribution over K classes with probabilities given by π∈Δ^{K}, where Δ^{K} denotes the K-simplex. They start with a forward process that interpolates between clean data c and a target distribution Cat(.;π) forming a direct extension of the Gaussian diffusion described above. If q defines a sequence of increasingly noisy latent variables zₜ where the time step t runs from t=0 (least noisy) to t=1 (most noise), then the marginal of zₜ conditional on c at time t is shown in equation (2) where aₜ∈[0,1] is a strictly decreasing function in t, with α₀≈1 and α₁≈0.

$$q ( {z}_{t} \vert c ) = Cat ( {z}_{t} ; {α}_{t} c + ( 1 - {α}_{t} ) π ) \qquad ( 2 )$$

This implies transition probabilities q(zₜ|zₛ)=Cat(zₜ; α_{t|s}zₛ+(1−α_{t|s})π) where α_{t|s}=αₜ/αₛ. This indicates that during each diffusion step from s→t, a fraction of the probability mass is transferred to the prior distribution 7. The reverse posterior is given in equation (3).

$$q ( {z}_{s} \vert {z}_{t} , c ) = Cat ( {z}_{s} ; \frac{[ {α}_{t \vert s} {z}_{t} + ( 1 - {α}_{t \vert s} ) 1 {π}^{T} {z}_{t} ] ⊙ [ {α}_{s} c + ( 1 - {α}_{s} ) π ]}{{α}_{t} {z}_{t}^{T} c + ( 1 - {α}_{t} ) {z}_{t}^{T} π} ) \qquad ( 3 )$$

In masked diffusion, π is set to m. At each noising step t, the input c transitions to a ‘masked’ state m with some probability. If an input transitions to m at any time t′, it will remain in this state for all t>t′: q(zₜ|zₜ′, =m)=Cat(zₜ;m). At time T, all inputs are masked with probability I. The marginal of the forward process is given by equation (4).

$$q ( {z}_{t} \vert c ) = Cat ( {z}_{t} ; {α}_{t} c + ( 1 - {α}_{t} ) π ) \qquad ( 4 )$$

From properties of the masking process the posterior q(zₛ|zₜ, c) simplifies to equation (5).

$$q ( {z}_{s} \vert {z}_{t} , c ) = \{ \begin{matrix}Cat ( {z}_{s} ; {z}_{t} ) , & {z}_{t} \neq m \\ Cat ( {z}_{s} ; \begin{matrix}( 1 - {α}_{s} ) m + ( {α}_{s} - {α}_{t} ) c \\ 1 - {α}_{t}\end{matrix} ) , & {z}_{t} = m\end{matrix} \qquad ( 5 )$$

During training, synthetic tabular datasets 514 of the plurality of synthetic datasets are provided to the diffusion model 516 where they are diffused or corrupted via a diffusion process to generate corresponding diffused datasets 524.

The machine learning model 512 is then trained to perform the reverse diffusion process on the diffused datasets 524. Specifically, during training, each of the diffused datasets 524 output by the diffusion model 516 is provided to the machine learning model 512 where the machine learning model 512 generates an output therefore (e.g., a predicted dataset 526). The goal is to have the machine learning model 512 generate, in response to processing a diffused dataset 524, the corresponding synthetic tabular dataset 514. This is accomplished by the evaluation module 518 comparing the output of the machine learning model 512 in response to a diffused dataset 524 (i.e., the predicted dataset 526) to the corresponding synthetic tabular dataset 514, generating a loss function therefrom and adjusting the parameters 528 of the machine learning model 512 to minimize the loss function. The loss function that is minimized may be any suitable loss function and may be based on the diffusion process used by the diffusion model 516 to corrupt the synthetic datasets. In some cases, training may comprise adjusting the parameters of the machine learning model 512 to minimize the variational upper or lower bound on the negative log likelihood.

For example, where the diffusion model 516 implements the diffusion process represented by equations (2) and (3), the parameters of the machine learning model 512 (wherein the machine learning model is denoted pe) may be adjusted so as to maximize the variational lower bound on log-likelihood (ELBO). Specifically, given a number of discretization steps T, defining s(i)=(i−1)/T and t(i)=i/T and using D_{KL} [·] to denote the Kullback-Leibler divergence, the Negative ELBO can be expressed by equation (6) where

$${\sum }_{i = 1}^{T} {D}_{KL} [ q ( {z}_{s ( i )} \vert {z}_{t ( i )} , c \vert \vert {p}_{θ} ( {z}_{s ( i )} \vert {z}_{t ( i )} ) ]$$

is the diffusion-related loss ( [symbol] _{diffusion})

$${E}_{q} [ - log {p}_{θ} ( c \vert {z}_{t ( 0 )} ) ] + {\sum }_{i = 1}^{T} {D}_{KL} [ q ( {z}_{s ( i )} \vert {z}_{t ( i )} , c \vert \vert {p}_{θ} ( {z}_{s ( i )} \vert {z}_{t ( i )} ) ] + {D}_{KL} [ q ( {z}_{t ( T )} \vert c \vert \vert {p}_{θ} ( {z}_{t ( T )} ) ] \qquad ( 6 )$$

In another example, where the diffusion model 516 implements the diffusion process represented by equations (4) and (5), as per Sahoo, the parameters of the machine learning model 512 may be adjusted to so as to maximize the variational lower bound on log-likelihood (ELBO) which is simplified, with respect to equation (6) to equation (7) where

$${\sum }_{i = 1}^{T} [ \frac{{α}_{t ( i )} - {α}_{s ( i )}}{1 - {α}_{t ( i )}} log 〈 {c}_{θ} ( {z}_{t ( i )} ) , c 〉 ]$$

is the diffusion-related loss ( [symbol] _{diffusion}).

$${E}_{q} [ - log {p}_{θ} ( c \vert {z}_{t ( 0 )} ) ] + {\sum }_{i = 1}^{T} [ \frac{{α}_{t ( i )} - {α}_{s ( i )}}{1 - {α}_{t ( i )}} log 〈 {c}_{θ} ( {z}_{t ( i )} ) , c 〉 ] + {D}_{KL} [ q ( {z}_{t ( T )} \vert c \vert \vert {p}_{θ} ( {z}_{t ( T )} ) ] \qquad ( 7 )$$

Once the machine learning model 512 has been trained to generate the synthetic datasets (i.e., it has learned how to reverse the diffusion process) then the resulting trained machine learning model, which may be referred to as a diffusion PFN 504, can be used to generate a synthetic dataset from scratch. Specifically, the trained machine learning model (i.e., diffusion PFN 504) may be provided with a diffused dataset (e.g., a random dataset) of the desired shape and size. The trained machine learning model (i.e., diffusion PFN 504) then removes the noise in the diffused dataset step by step to create a new dataset of the desired shape and size. Since the diffusion PFN 504 has learned to reverse the process from synthetic datasets from a prior, the new dataset it generates has a distribution that is consistent with the prior it was trained on.

However, once the machine learning model has been trained to generate datasets in accordance with the prior (i.e., to generate p(D)) (e.g., once the diffusion PFN 504 has been generated), the trained machine learning model (i.e., the diffusion PFN 504) is modified or conditioned, by the second system 506 (i.e., the conditioning module 530 thereof), to perform imputation. The original trained machine learned model (e.g., diffusion PFN 504) is referred to as unconditioned or an unconditional model and the modified model (e.g., conditioned diffusion PFN 508) may be referred to as a conditioned or conditional model. An unconditional diffusion-trained model models a data distribution p(A) whereas a conditional diffusion model models a conditional distribution p(A|B), where the output of the model is guided by additional information B. In other words, a conditional or conditioned diffusion-trained model takes additional inputs as conditions to control the generation process.

In the image context, in-painting is something that is commonly performed with a machine learning model that has been trained, using diffusion modelling, to generate images. In-painting is the process of inferring missing parts in an image based on available regions specified by a binary mask (which may be referred to as a segmentation mask). Specifically, a machine learning model that has been trained using a diffusion model to generate images may be able to generate all of the pixels of an image together in response to receiving a set of random inputs that match the desired shape and size of the image. However, such a trained model can also be modified to condition on available image regions to produce high quality inferences (e.g., missing image regions). Specifically, a modified model can be generated that leverages the trained model's ability to generate images while conditioning on the observed part(s) of an image so that the modified model generates missing parts of the image based on the observed part(s) of the image.

In some cases, this may be implemented by generating a mask (e.g., a binary mask) which indicates which pixels of the image are to be generated (e.g., the pixels that are missing) and generating a modified model to perform conditioned processing—i.e., to use the provided context (the pixels of the image that are not to be generated or modified) and the mask to generate the identified pixels using the reverse diffusion process.

The model may be modified to implement conditional processing in a number of different ways. In some cases, this may be implemented via a conditional denoising autoencoder ∈_{θ}(zₜ, t, r) which allows the synthesis (i.e., image generation) process to be controlled through inputs r, such as, but not limited to, the map and the input image. See, for example, Rombach et al., “High-Resolution Image Synthesis with Latent Diffusion Models”, Proceedings of the IEEE/CVF Conference on Computer Vision and Pattern Recognition, pages 10684-10695, 2022, for a description of conditioning a diffusion model for inpainting.

Inpainting can be seen as one example or form of imputation (i.e., estimating or inferring missing values in a dataset using algorithms and other datapoints). Thus, methods similar to those used to condition a model trained to generate an image to perform inpainting can be used to condition the trained machine learning model (e.g., diffusion PFN 504) to perform imputation—i.e., generate missing data from a dataset. Specifically, the trained machine learning model may be conditioned down, for example, to receive (i) an input dataset and (ii) a mask indicating which datapoints or elements of the input dataset are to be generated or predicted; and generate or predict the identified elements based on the other elements of the input dataset. Once the trained machine learning model (e.g., diffusion PFN 504) has been conditioned to generate missing data from a dataset (e.g., the conditioned diffusion PFN 508 has been generated) it can be used to perform a variety of tasks.

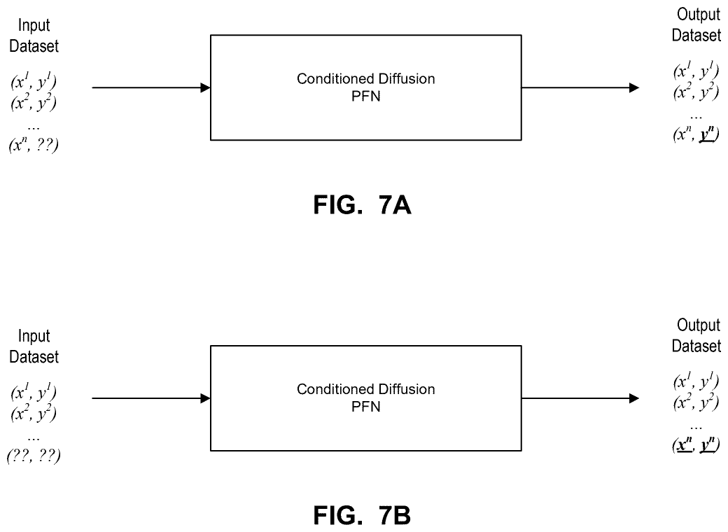

For example, as shown in FIG. 7A, a conditioned diffusion PFN may be used to perform in-context classification or regression by providing the conditioned diffusion PFN with an input dataset that comprises a plurality of example datapoints (x¹, y¹; x², y², . . . xⁿ⁻¹, yⁿ⁻¹) and a partial datapoint, with only, for example, a set of features (e.g., xⁿ), but without the corresponding target (e.g., yⁿ)—and causing the conditioned diffusion PFN to generate the missing target (e.g., yⁿ). In this way the conditioned diffusion PFN acts like a PFN (or TabPFN) described above in that it can generate a prediction y, based on a test dataset (x¹, y¹; x², y², . . . xⁿ⁻¹, yⁿ⁻¹) and an input xⁿ. Thus, it can perform in-context learning.

In another example, as shown in FIG. 7B, a conditioned diffusion PFN may be used to perform in-context generation of datapoints by providing the conditioned diffusion PFN with an input dataset that comprises a plurality of datapoints (x¹, y¹; x², y², . . . xⁿ⁻¹, yⁿ⁻¹) and causing the conditioned diffusion PFN to generate an additional datapoint (e.g., xⁿ, yⁿ) that is consistent with the provided datapoints.

In another example, where a mask is used to identify the elements of an input tabular dataset to generate, then the conditioned diffusion PFN may be used to generate an entire dataset by providing the conditioned diffusion PFN with an input tabular dataset of the desired shape and size with random or noise datapoints, and generating a mask that indicates that all of the datapoints of the dataset are to be generated.

Furthermore, since a diffusion PFN learns the distribution p(D), when a conditioned version of the diffusion PFN is used to perform classification or regression, the conditioned diffusion PFN can not only output a final prediction (a number) but it can predict a distribution over those numbers. So, it can perform uncertainty quantification. This is the difference between saying the result is 800 versus saying with 90% confidence the result is between 790 and 810. Accordingly, by learning the entire distribution p(D), a diffusion PFN can generate density estimates to get uncertainty estimates.

Accordingly, a conditioned diffusion PFN can be used to perform all of the tasks that a PFN or TabPFN can perform (e.g., classification and regression), but it can also be used to perform a number of other tasks such as, but not limited to, generation of datapoints consistent with a dataset and complete dataset generation, making it a much more valuable and flexible model.

In the examples described herein, once the conditioned diffusion PFN 508 has been generated, the conditioned diffusion PFN 508 is used in the third system 510 to perform event prediction.

In some cases, the conditioned diffusion PFN 508 is used to perform event prediction by providing the conditioned diffusion PFN 508 with: (1) an input tabular dataset 532 comprising a plurality of datapoints, each datapoint comprising one or more elements, and (2) information (e.g., a mask 534) identifying one or more elements of the input tabular dataset 532 that are to be generated or predicted. The plurality of datapoints in the input tabular dataset 532 comprise one or more training datapoints and an input datapoint.

Each training datapoint represents a set of features related to an example (e.g., historical) record and whether the event occurred for that record. In particular, each training datapoint comprises a set of elements that represent a set of features related to the record and one or more elements that represents whether the event occurred. The input datapoint represents the set of features for a new record, but the one or more elements representing whether the event occurred is missing or does not have valid data. The information (e.g., mask 534) then identifies the missing one or more elements (i.e., the one or more elements representing whether the event occurred for the new record) as the element(s) to be generated or predicted.

In response to receiving the input tabular dataset 532 and the information (e.g., mask 534) identifying the elements of the input tabular dataset 532 to be generated or predicted, the conditioned diffusion PFN 508 generates or predicts the identified elements of the input tabular dataset 532 (e.g., prediction 536) based on the other elements of the input tabular dataset 532 (i.e., the set of features for the input datapoint and the training datapoints). In some cases, the output of the conditioned diffusion PFN 508 may be in the form of an output tabular dataset that comprises (1) all of the elements of the input tabular dataset 532 except the identified elements, and (2) the prediction for the identified elements (e.g., the prediction 536). The prediction 536 can then be extracted from the output tabular dataset.

What set of features are in the datapoints will vary based on the event. For example, if the event is an individual defaulting on their credit card the set of features may comprise features such as, but not limited to, the age of the individual, the credit score of the individual, the salary or income of the individual, etc. Therefore, in this example, the training datapoints demonstrate the relationship between the set of features and default of a credit card so that the conditioned diffusion PFN 508 can predict whether an individual will default on the credit card based on the set of features for that individual.

In some cases, all or a portion of the data 538 used to generate the input tabular dataset 532 may be received from the source database system 402 or the EDPP 404 via, for example, a data ingestor 540 and stored in the repository 520. In some cases, the training datapoints of the input tabular dataset 532 may be received from the source database system 402 of the EDPP 404 and the input datapoint may be received from a user via a user device 420 that is connected over a data communication link 542 to the user interface 418 of the cloud-based computing cluster 406. For example, the user may input the elements of the input datapoint via a web browser 546 or some other application that operates on the user device 420.

In some cases, the prediction 536 generated by the conditioned diffusion PFN 508 is provided to the user device 420. For example, the prediction 536 may be provided to the user via the web browser 546 or some other application that operates on the user device 420.

The conditioned diffusion PFN 508 may be used to predict the same event for multiple different new records using the same training datapoints. For example, the same training datapoints maybe used to predict (a) whether a first individual will default on a credit card, and (b) whether a second, different, individual will default on a credit card. In these cases, it may be that only the input datapoint differs between predicting (a) and (b).

In the same way that a PFN can operate on different datasets without having to retrain the PFN, the conditioned diffusion PFN 508 may be used to predict different events, or even the same event using different features, by providing the conditioned diffusion PFN 508 with different training datapoints. For example, one set of training datapoints may be used to predict a first event and different set of training datapoints may be used to predict, a second event; or one set of training datapoints may be used to predict a first event using a first set of features and a different set of training datapoints may be used to predict the same first event using a second set of features.

### Example Computer

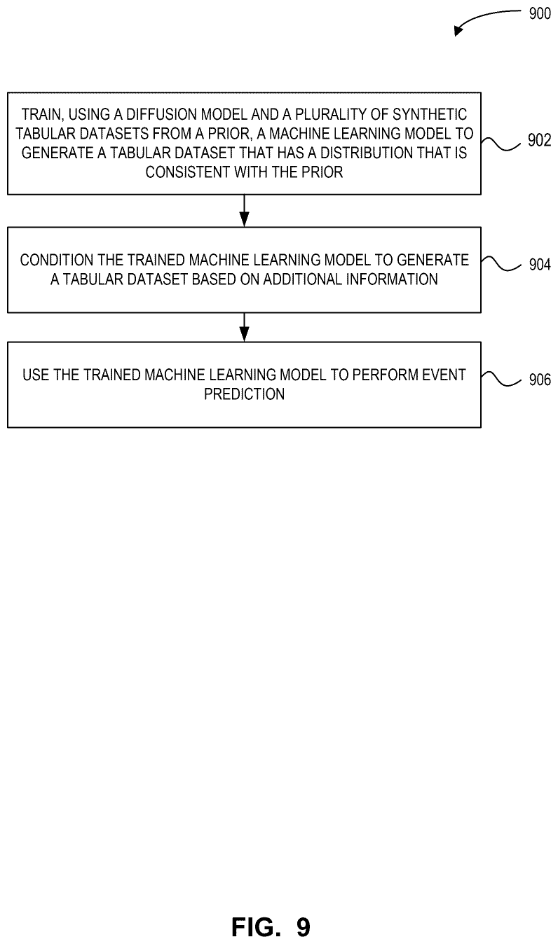

Reference is now made to FIG. 8 which illustrates a simplified block diagram of an example computer 800. Computer 800 is an example implementation of a computer which may implement the source database system 402, EDPP 404, one or more components of the cloud-based computing cluster 406 of FIGS. 4 and 5 and/or the method 900 of FIG. 9. Computer 800 has at least one processor 802 operatively coupled to at least one memory 804, at least one communications interface 806 (also referred to herein as a network interface), and at least one input/output (I/O) device 808.

The at least one memory 804 includes a volatile memory that stores instructions executed or executable by the processor 802, and input and output data used or generated during execution of the instructions. The memory 804 may also include non-volatile memory used to store input and/or output data—e.g., within a database—along with program code containing executable instructions.

The processor 802 may transmit or receive data via the communications interface 806 and may also transmit or receive data via any additional input/output device 808 as appropriate.

In some cases, the processor 802 includes a system of central processing units (CPUs) 810. In other cases, the processor 802 includes a system of one or more CPUs 810 and one or more Graphical Processing Units (GPUs) 812 that are coupled together. For example, any combination of the machine learning models 512, diffusion PFNs 504, and conditioned diffusion PFNs 508 described herein may execute neural network computations on CPU and GPU hardware, such as the system of CPUs 810 and GPUs 812 of FIG. 8.

### Method

Reference is now made to FIG. 9 which illustrates an example method 900 for performing event prediction using a machine learning model. The method 900 beings at block 902 where a machine learning model (e.g., a machine learning model with a transformer architecture) is trained, using a diffusion model and a plurality of synthetic tabular datasets representing a prior, to generate a tabular dataset that has a distribution that is consistent with the prior. In other words, the machine learning model is trained to generate p(D). As described above, in some cases, the prior may be based on Bayesian Neural Networks (BNNs) and/or Structural Causal Models (SCMs) to model complex feature dependencies and potential causal mechanisms underlying tabular data and the plurality of synthetic tabular datasets may be generated by sampling one or more BNNs and/or one or more SCMs.

As described above, training the machine learning model using a diffusion model and the plurality of synthetic tabular datasets may comprises diffusing each of the plurality of synthetic tabular datasets, passing each of the plurality of diffused datasets through the machine learning model to generate a predicted dataset, and adjusting the parameters of the machine learning model based on a comparison of each of the predicted datasets and the corresponding synthetic tabular dataset so that the machine learning model performs the reverse of the diffusion process. In some cases, the adjusting of the parameters of the machine learning model may be iterative. For example, in some cases (1) diffused datasets may be generated for a set of synthetic tabular datasets, (2) the set of synthetic tabular datasets may be processed by the machine learning model to generate corresponding predicted datasets, and (3) the parameters of the machine learning model may be adjusted or updated based on a comparison of the predicted datasets and their corresponding synthetic tabular datasets. Steps (1), (2) and (3) may then be repeated for a set of synthetic tabular datasets (which may be the same set or a different set from the one used in the previous iteration) and so on. This may be repeated until an error or loss metric based on a comparison of the predicted datasets and their corresponding synthetic tabular datasets reaches a certain level. Once the machine learning model has been trained, the method 900 proceeds to block 904.

At block 904, the trained machine learning model (e.g., the diffusion PFN) is conditioned to perform the generation of all or a portion of a dataset based on additional information. In some cases, the additional information comprises (i) an input tabular dataset comprising one or more datapoints, each datapoint comprising one or more elements, and (ii) information (e.g., a mask) identifying one or more elements of the input tabular dataset that are to be generated, and the conditioned trained machine learning model (e.g., the conditioned diffusion PFN) is configured to generate the identified one or more elements of the input tabular dataset based on the other elements of the input tabular dataset. The identified one or more elements of the input tabular dataset that are to be generated may be any combination of the elements of the input tabular dataset. For example, the identified elements may comprise all the elements of one or more datapoints of the input tabular dataset, or the identified elements may comprise only a subset of the elements of one or more datapoints of the input tabular dataset.

As described above, once the trained model has been conditioned in this way to generate identified elements of an input tabular dataset based on the other elements of the input tabular dataset it can be used to perform a number of tasks in context on a new, unseen dataset, including, but not limited to, classification, regression, data generation, data imputation, density estimation and qualifying model uncertainly and/or detecting anomalous inputs.

Once the trained machine learning model has been conditioned, the method 900 proceeds to block 906.

At block 906, the conditioned and trained machine learning model (e.g., conditioned diffusion PFN) is used to perform event prediction. In some cases, the conditioned diffusion PFN is used to perform event prediction by providing the conditioned diffusion PFN with: (1) an input tabular dataset comprising a plurality of datapoints, each datapoint comprising one or more elements, and (2) information (e.g., a mask) identifying one or more elements of the input tabular dataset that are to be generated or predicted. The plurality of datapoints in the input tabular dataset comprise one or more training datapoints and an input datapoint.

Each training datapoint represents a set of features related to an example (e.g., historical) record and whether the event occurred for that record. In particular, each training datapoint comprises a set of elements that represent a set of features related to the record and one or more elements that represent whether the event occurred. The input datapoint represents the set of features for a new record, but the one or more elements representing whether the event occurred is missing or does not have valid data. The information (e.g., mask) then identifies the missing one or more elements (i.e., the one or more elements representing whether the event occurred for the new record) as the element(s) to be generated or predicted.

In response to receiving the input dataset and the information (e.g., mask 534) identifying the elements of the input tabular dataset to be generated or predicted, the conditioned diffusion PFN generates or predicts the identified elements of the input tabular dataset (e.g., the prediction) based on the other elements of the input tabular dataset (i.e., the set of features for the input datapoint and the training datapoints). This causes the conditioned diffusion PFN to perform event prediction.

### Example Use Cases

The conditioned diffusion PFN 508 described above can be used to perform event prediction in a variety of industries including, but not limited to, healthcare, education, manufacturing, energy and utilities, technology and cybersecurity, real estate and construction, transportation and logistics, education, hospitality and travel, and financial.

Specifically, the conditioned diffusion PFN 508 described above may be able to predict whether an entity (e.g., an individual or a business/enterprise) will apply for, or request, a financial product (or a change to a financial product) within a predetermined time in the future (e.g., within the next three months). The prediction generated by the conditioned diffusion PFN 508 may then be used, for example, to determine whether to target the entity (e.g., individual or business/enterprise) for marketing of that financial product. Examples of financial products for which acquisition thereof within a predetermined period in the future may be predicted include, but are not limited to, a credit card (CC), unsecured line of credit (ULOC), unsecured loan (ULOAN), real estate secured lending (RESL), balance transfer, direct investing, wealth, chequing account, personal investment account, savings account, term life policy, overdraft protection, trade account, travel medical insurance policy, balance protection insurance, and a credit limit increase to a financial product such as a ULOC, HELOC and CC. The features that are used to predict whether an entity (e.g., individual or business/enterprise) will obtain or request a financial product may vary based on the financial product.

The conditioned diffusion PFN 508 described above may also, or alternatively, be used to predict financial product attrition. For example, the conditioned diffusion PFN 508 described above may be used to predict whether a credit card holder will cancel their credit card. Such a prediction generated by the conditioned diffusion PFN 508 may be used by the financial product provider to proactively contact the client to persuade them to keep, or continue with, the product.

The conditioned diffusion PFN 508 described above may also, or alternatively, be used to predict features or events related to a financial product. For example, the conditioned diffusion PFN 508 may be used to predict ULOC utilization, HELOC utilization, a credit limit decrease and/or cash flow management (e.g., estimated money in/money out) for an account.

The conditioned diffusion PFN 508 described above may also, or alternatively, be used to predict whether, an entity (e.g., individual or business/enterprise) will become delinquent with respect to a financial product. The prediction generated by the conditioned diffusion PFN 508 can then be used to determine whether the financial product provider is to provide the financial product to the entity. For example, the conditioned diffusion PFN 508 may used to predict whether an entity will be delinquent with respect to one or more of a credit card, ULOC, ULON, and RESL.

The conditioned diffusion PFN 508 described above may also, or alternatively, be used to predict fraudulent activity with respect to a financial product. In these cases, the prediction generated by the conditioned diffusion PFN 508 may be used to take proactive action such as, for example, re-issuing a new credit card for an CC account which has been identified as being at risk for fraudulent use. For example, the conditioned diffusion PFN 508 may be used to detect the risk or likelihood of an account being fraudulently taken over, the risk or likelihood of mule fraud for an account (i.e., the risk that an entity moves or transfers ill-gotten funds via the account), or the risk or likelihood of an account being used for money laundering. In another example, the conditioned diffusion PFN 508 may also be able to predict that an application for a financial product (e.g., CC) is fraudulent, and/or there has been an account breach (e.g., a fraudulent transaction) on a CC or a debit account.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A system for performing event prediction, the system comprising:
a memory, a communication interface, and at least one processor operatively coupled to the memory and the communication interface;
the at least one processor configured to:
train, using a diffusion model and a plurality of synthetic tabular datasets representing a prior, a machine learning model to generate a tabular dataset that has a distribution that is consistent with the prior;
condition the trained machine learning model to: receive (i) an input tabular dataset comprising one or more datapoints, each datapoint comprising one or more elements, and (ii) information identifying one or more elements of the input tabular dataset that are to be predicted, and predict the identified one or more elements of the input tabular dataset based on the other elements of the input tabular dataset; and
use the conditioned trained machine learning model to perform event prediction.

2. The system of claim 1, wherein the at least one processor is configured to use the conditioned trained machine learning model to perform event prediction by providing the conditioned trained machine learning model with (i) an event input tabular dataset comprising a plurality of datapoints and (ii) event information identifying one or more elements of the event input tabular dataset to be predicted, wherein the plurality of datapoints comprise one or more training datapoints and an input datapoint, and the event information identifies an element of the input datapoint to be predicted.

3. The system of claim 2, wherein each training datapoint comprises a set of elements that represent a set of features of a record and an element that represents an occurrence of the event for the record, and the input datapoint comprises a set of elements that represent the set of features for a new record.

4. The system of claim 3, wherein:
the input datapoint comprises an element that represents an occurrence of the event for the new record and the element that represents the occurrence of the event for the new record does not comprise valid data; and
the event information identifies the element of the input datapoint that represents the occurrence of the event for the new record as an element to be predicted such that the conditioned trained machine learning model predicts the occurrence of the event for the new record.

5. The system of claim 1, wherein the event information comprises a mask.

6. The system of claim 1, wherein the machine learning model comprises a transformer architecture.

7. The system of claim 6, wherein the machine learning model is configured to tokenize each element of the event input tabular dataset.

8. The system of claim 1, wherein using the conditioned trained machine learning model to perform event prediction comprises using the conditioned trained machine learning model to predict a likelihood of an entity requesting a financial product within a predetermined period of time.

9. The system of claim 8, wherein the financial product is a credit card, unsecured line of credit, unsecured loan, real estate secured lending, investing account, checking account, personal investment, savings account, term life policy, overdraft protection, trade account, travel medical insurance, or balance protection insurance.

10. The system of claim 1, wherein using the conditioned trained machine learning model to perform event prediction comprises using the conditioned trained machine learning model to predict fraudulent activity related to a financial product.

11. The system of claim 10, wherein predicting the fraudulent activity related to the financial product comprises predicting an account take over risk, predicting mule account risk, predicting money laundering account risk, predicting application fraud, or predicting breach of an account.

12. The system of claim 1, wherein using the conditioned trained machine learning model to perform event prediction comprises using the conditioned trained machine learning model to predict delinquency related to a financial product.

13. The system of claim 12, wherein the financial product comprises a credit card, an unsecured line of credit, an unsecured loan, or a real estate secured lending.

14. The system of claim 1, wherein the at least one processor is further configured to generate one or more synthetic tabular datasets of the plurality of synthetic tabular datasets by sampling a Bayesian neural network.

15. The system of claim 1, wherein the at least one processor is further configured to generate one or more synthetic tabular datasets of the plurality of synthetic tabular datasets by sampling a structural causal model.

16. The system of claim 1, wherein the at least one processor is configured to train the machine learning model using the diffusion model and the plurality of synthetic tabular datasets by diffusing each of the plurality of synthetic tabular datasets in accordance with a diffusion process to generate a plurality of diffused datasets and adjusting parameters of the machine learning model so that the machine learning model reverses the diffusion process on the plurality of diffused datasets.

17. The system of claim 16, wherein adjusting the parameters of the machine learning model so that the machine learning model reverses the diffusion process comprises adjusting the parameters of the machine learning model so that the machine learning model generates, in response to receiving a diffused dataset, the corresponding synthetic tabular dataset.

18. A method for performing event prediction, the method executed in a computing environment comprising at least one processor, a communication interface, and memory, and the method comprising:
training, using a diffusion model and a plurality of synthetic tabular datasets representing a prior, a machine learning model to generate a tabular dataset that has a distribution that is consistent with the prior;
conditioning the trained machine learning model to: receive (i) an input tabular dataset comprising one or more datapoints, each datapoint comprising one or more elements, and (ii) information identifying one or more elements of the input tabular dataset that are to be predicted, and predict the identified one or more elements of the input tabular dataset based on the other elements of the input tabular dataset; and
using the conditioned trained machine learning model to perform event prediction.

19. The method of claim 18, wherein using the conditioned trained machine learning model to perform event prediction comprises providing the conditioned trained machine learning model with an event input tabular dataset comprising a plurality of datapoints and event information identifying one or more elements of the event input tabular dataset to be predicted, wherein the plurality of datapoints comprise one or more training datapoints and an input datapoint, and the event information identifies an element of the input datapoint to be predicted.

20. A non-transitory computer readable medium storing computer executable instructions which, when executed by at least one computer processor, cause the at least one computer processor to carry out a method for performing event prediction, the method comprising:
training, using a diffusion model and a plurality of synthetic tabular datasets representing a prior, a machine learning model to generate a tabular dataset that has a distribution that is consistent with the prior;
conditioning the trained machine learning model to: receive (i) an input tabular dataset comprising one or more datapoints, each datapoint comprising one or more elements, and (ii) information identifying one or more elements of the input tabular dataset that are to be predicted, and predict the identified one or more elements of the input tabular dataset based on the other elements of the input tabular dataset; and
using the conditioned trained machine learning model to perform event prediction.
